(19) United States
(12) Patent Application Publication
(10) Pub. No.: US 2008/0178717 A1
(43) Pub. Date: Jul. 31, 2008

(54) FAST SWITCH HAND TOOL

(76) Inventor: Zu-Shung Shu, Ta Li City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/669,497

(22) Filed: Jan. 31, 2007

(51) Int. Cl. B25G 1/08; B25B 13/46

(52) U.S. Cl. 81/490; 81/60

(57) ABSTRACT

A quick switch hand tool includes a base board, a plate, a shell, and a cover connected together. A driving shaft is rotatably disposed in the base board, the plate, the shell and the cover. A switch means is mounted on the base board and is provided for switching the direction of the driving shaft. A quick actuating member is disposed on the driving shaft and provides the effect of quick actuating.

### FIELD OF THE INVENTION

The present invention relates to a fast switch hand tool, more particularly to a fast switch hand tool having switch means.

### DESCRIPTION OF THE RELATED ART

Referring to Taiwan Patent No. 155346, discloses a prior wrench comprising a ratchet included on two ends thereof and provided for driving a screw. However, the prior wrench can only drive two standards screws and not provide the effect of fast poking. It's not convenient for a user to carry on several kinds of wrenches.

### SUMMARY OF THE INVENTION

It is therefore the purpose of this invention to provide a fast switch hand tool, which comprising a base board, a plate, a shell, a cover, a driving shaft disposing in the said members and connecting to all of them, a switch means mounting on the base board and provided for the driving shaft the effect of driving to switch the direction, and a fast poke member disposing on the driving shaft and provided the effect of fast poking.

Other objectives, advantages, and features of the invention will become more apparent from the following detailed description when taken in conjunction with the accompanying drawings.

### BRIEF DESCRIPTION OF THE DRAWINGS

FIG. 1 is a perspective view illustrating the first embodiment of a fast switch hand tool in accordance with the present invention.

FIG. 2 is an exploded perspective view illustrating the first embodiment of a fast switch hand tool in accordance with the present invention.

FIG. 3 is a side view illustrating the first embodiment of a fast switch hand tool in accordance with the present invention.

FIG. 4 is a section view taken along plane 4-4 in FIG. 3, showing poking the poke member.

FIG. 5 is similar to FIG. 4 but shows before poking the poke member.

FIG. 6 is similar to FIG. 4 but shows to switch the poke member.

FIG. 7 is a section view taken along plane 7-7 in FIG. 3, showing the cover pivotally installing on the shell.

FIG. 8 is a section view taken along plane 8-8 in FIG. 3, showing the fast poke member.

FIG. 9 is a section view illustrating the cover of a fast switch hand tool in accordance with the present invention.

FIG. 10 is a perspective view illustrating the second embodiment of a fast switch hand tool in accordance with the present invention.

FIG. 11 is an exploded perspective view illustrating the second embodiment of a fast switch hand tool in accordance with the present invention.

### DETAILED DESCRIPTION OF THE PREFERRED EMBODIMENT

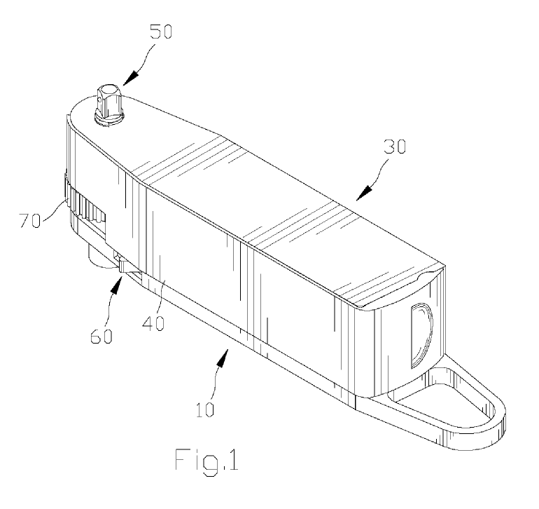

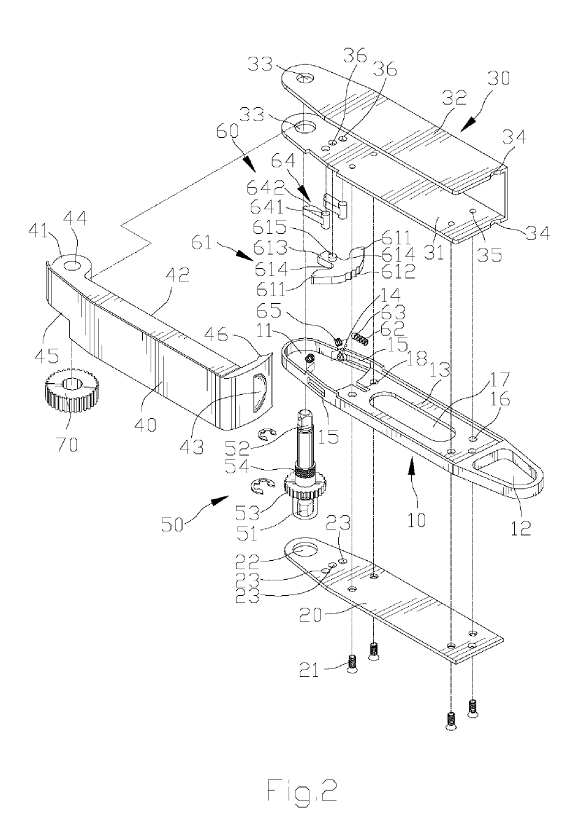

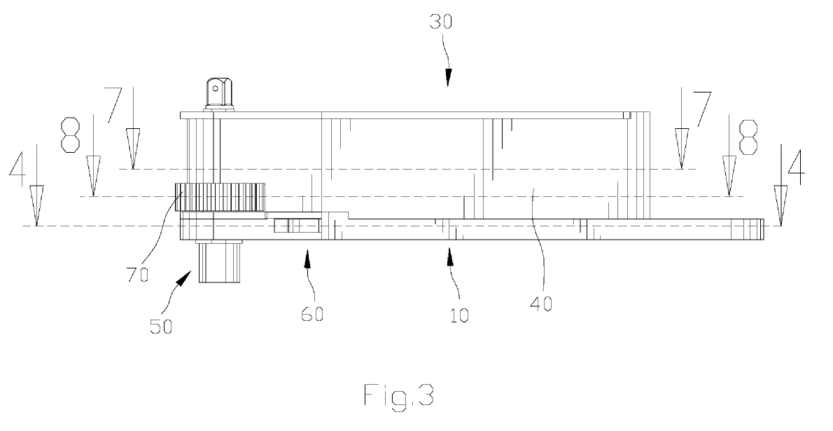

Referring to FIGS. 1 through 3, the first embodiment of a fast switch hand tool in accordance with the present invention comprises a base board 10, a plate 20, a shell 30 and a cover 40, a driving shaft 50 disposing through above members and connecting to each other, a switch means 60 mounting on the base board 10 and providing for the driving shaft 50 switching the direction, and a fast poke member 70 mounting on the driving shaft 50 and providing the effect for fast poking.

A space 11 is formed on an end of the base board 10, a hanging hole 12 is formed on another end thereof, a connecting portion 13 is defined between the space 11 and the hanging hole 12, and the two inside walls of the space 11 both includes a protrusion 14 and a slot 15. The connecting portion 13 is a thinner plate than the base board 10, a plurality of combining hole 16 and a through portion 17 are formed on the connecting portion 13, and a recess 18 is extended from a side of the space 11 to the connecting portion 13.

The plate 20 presses on the connecting portion 13 of the base board 10 and disposes in the combining holes 16 via a plurality of fixed element 21. A through hole 22 and three coupling holes 23 are formed on an end of the plate 20.

The shell 30 is U-shaped and includes a base 31 and a top 32. Two through holes 33 are respectively formed on an end of the base 31 and the top 32, and two concavities 34 are respectively defined on the side of another end thereof. A plurality of fixed hole 35 and three coupling holes 36 are formed on the base 31. The shell 30 couples to the base board 10 via the fixed elements 21 of the plate 20 fixing in the fixed holes 35 through the combining holes 16 of the base board 10.

The cover 40 includes a pivot portion 41, a compartment 42 and a poke portion 43. The pivot portion 41 which disposing in the shell 30 provides a pivot hole 44 corresponding to the through hole 33, and a concave portion 45 which is formed on a side of the pivot portion 41 exactly installs the fast poke member 70. A protrusion 46 is formed on the poke portion 43 corresponding to the concavity 34 of the shell 30, and the outer surface of the poke portion 43 is hollow such that it's easy to poke.

The driving shaft 50 which respectively through the through hole 22 of the plate 20, the through holes 33 of the shell 30 and the pivot hole 44 of the cover 40 disposes in the space 11 of the base board 10 and respectively hooks the through hole 22 of the plate 20 and the through holes 33 of the shell 30 via a C-clip. A driving hole 51 is defined on an end of the driving shaft 50 and a driving head 52 is formed on another end thereof. Further, the driving hole 51 exposes from the plate 20 and the driving head 52 exposes from the shell 30. A ratchet 53 which mounts on the driving shaft 50 near the driving hole 51 receives in the space 11 of the base board 10, a holding portion 54 which is situated on the driving shaft 50 where the shell 30 is disposed on, is embossed, and the fast poke member 70 retains on the holding portion 54 by means of installing between the base 31 and the cover 40.

The switch means 60 includes a poke member 61, an elastic portion 62, a ball 63, two poke blocks 64 and two elastic elements 65. Two pawls 611 which are formed on the two ends of the poke member 61 respectively dispose to the slots 15 of the base board 10. A retaining portion 612 is defined next to the two pawls 611 and having three concavities. A protruding block 613 is opposite to the retaining portion 612, and two recesses 614 are respectively formed on the two sides of the protruding block 613. A protruding portion 615 which is defined on the upper surface of the protruding block 613 exactly engages to the coupling hole 23 of the plate 20 and the coupling hole 36 of the shell 30. The elastic portion 62 receives in the recess 18 of the connecting portion 13, and the ball 63 receives between the elastic portion 62 and the retaining portion 612. The two poke blocks 64 dispose in the two recesses 614 on the two sides of the protruding block 613. An extending portion 641 which is formed on an end of the poke block 64 pivotally disposes to the coupling hole 23 of the plate 20 and the coupling hole 36 of the shell 30. An engaged portion 642 formed on another end of the poke block 64 exactly engages with the ratchet 53 of the driving shaft 50. The elastic element 65 mounts on the protrusion 14 of the base board 10 and pushes the poke block 64.

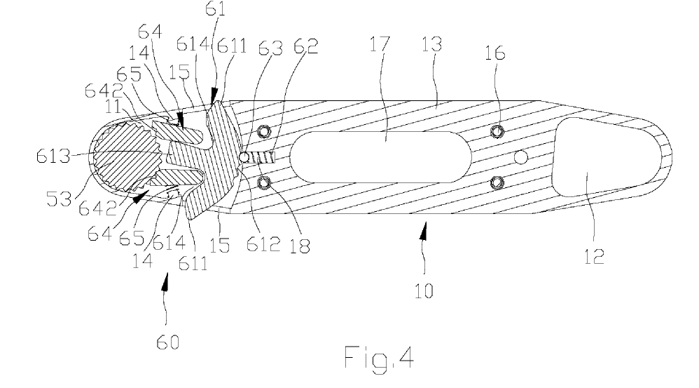

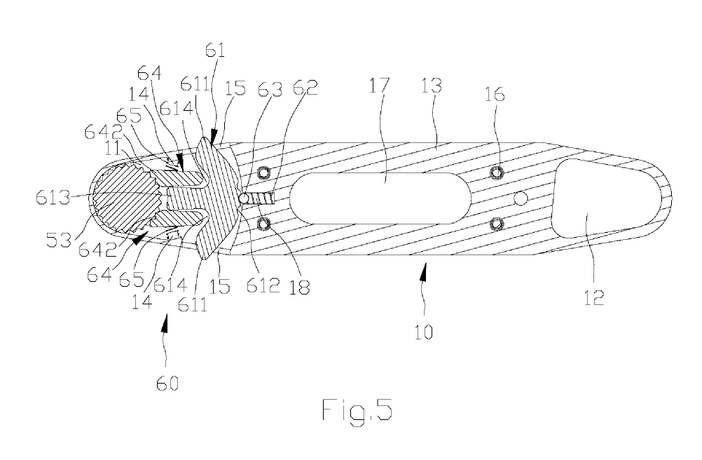

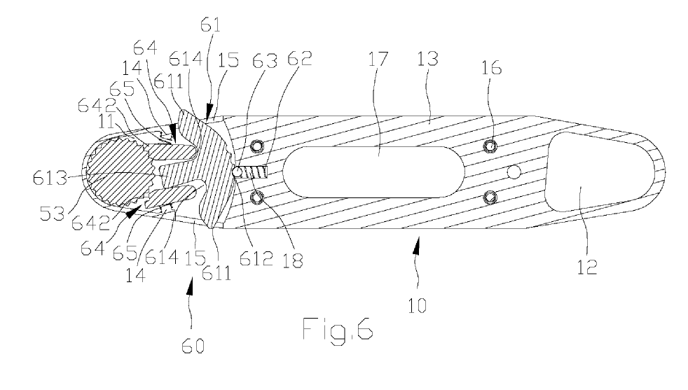

Referring FIGS. 4 through 6, to poke one of the pawls 611 to move the poke member 61 and the concavity of the retaining portion 612 near the said pawls 611 retains the ball 63. And the protruding block 613 presses one of the poke blocks 64 near the said pawls 611, and there's a tolerance between the ratchet 53 and the protruding block 613. The said poke block 64 presses the elastic element 65, and another poke block 64 engages with the ratchet 53 then.

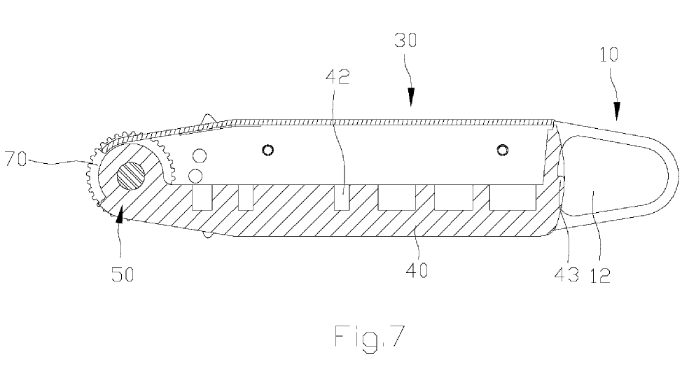

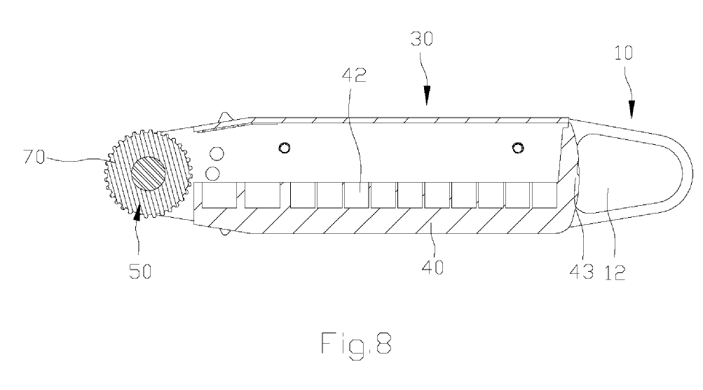

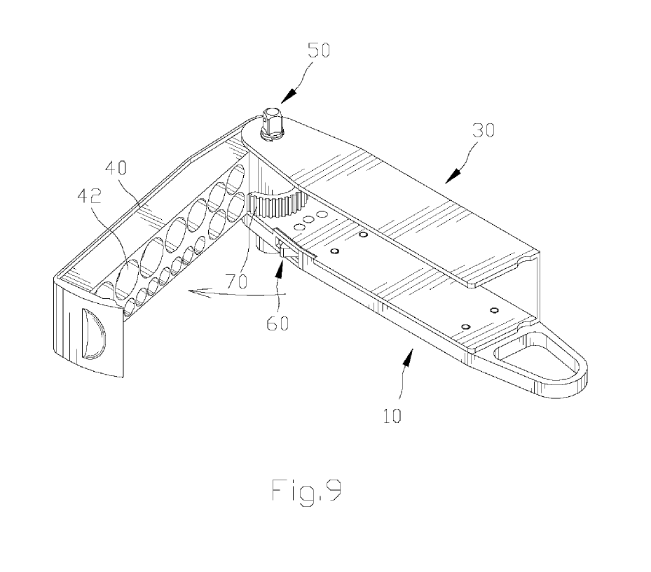

Referring FIGS. 7 through 9, the cover 40 pivotally mounts on the driving shaft 50, the driving shaft 50 disposes in the shell 30, and the cover 40 pivotally covers the shell 30. It's easy to pivot the cover 40 via turning the poke portion 43 of the cover 40. The compartment 42 of the shell 40 defines a plurality of holes provided for placing different standards of tool bits. And these tool bits could dispose in the driving hole 51 of the driving shaft 50.

The fast poke member 70 protrudes from the shell 40 so that a user could fast drive the driving shaft 50 to turn via the fast poke member 70.

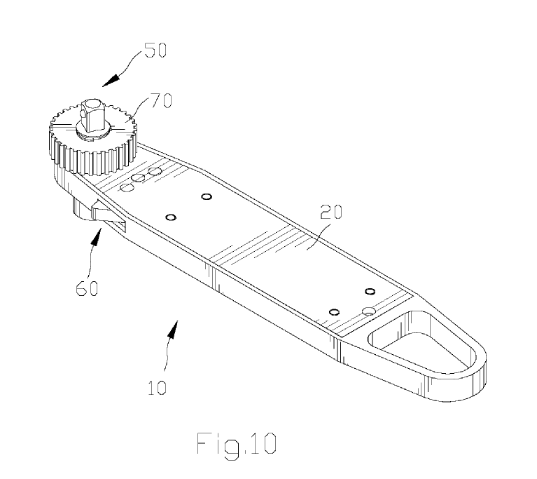

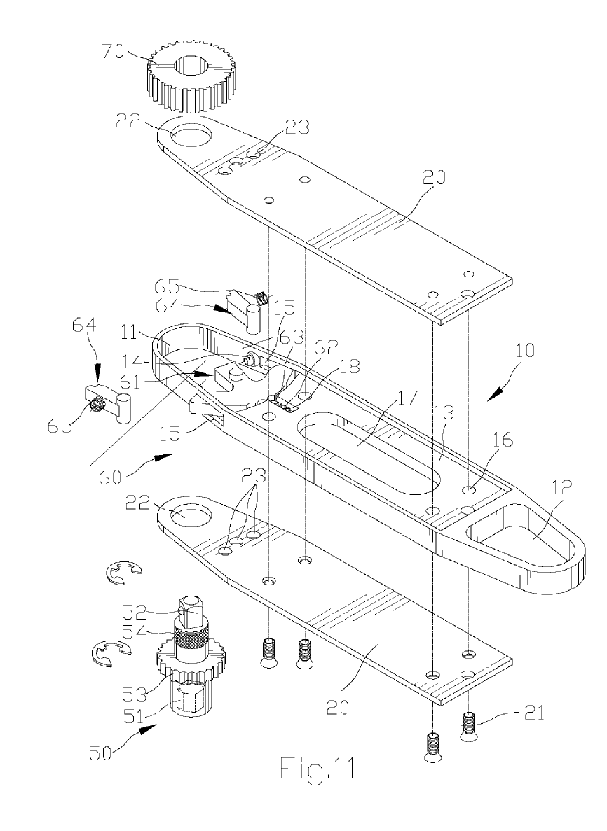

Referring FIGS. 10 and 11, the second embodiment of a fast switch hand tool in accordance with the present invention comprises the base board 10, the plate 20 covering the top and the base of the base board 10, the driving hole 51 of the driving shaft 50 mounted in the through hole 22 of the lower plate 20, and the driving head 52 of the driving shaft 50 mounted in the through hole 22 of the upper plate 20. And the fast poke member 70 disposes on the driving shaft 50 and protrudes from thereof so that a user could fast turn the fast poke member 70.

Summarizing the above-mentioned, the advantages of the present invention are:

1. The fast switch hand tool comprises the fast poke member providing the effect for fast driving the screw.

2. The fast switch hand tool comprises the shell including the compartment defining a plurality of holes provided for placing different standards of tool bits.

3. The fast switch hand tool comprises the switch means providing the effect for fast switching the direction.

1. A quick switch hand tool comprising:
a base board;
a driving shaft disposed in an end of the base board, wherein the driving shaft includes a driving hole on an end thereof and a driving head on another end thereof, wherein the driving hole and the driving head respectively protrude from the plate and the shell;
a ratchet mounted on the driving shaft;
a switch means included in the base board and provided for switching direction of the driving shaft, wherein the switch means comprises an actuating member, two actuating blocks, and two elastic elements, with two ends of the actuating member respectively including a pawl protruding from the base board, with two recesses formed on the actuating member receiving the actuating blocks engaging with the ratchet, with the elastic elements pressing the actuating blocks, and with the actuating member further including a retaining portion;
a shell fixed on a side of the base board;
a cover covering the shell; and
a plurality of tool bits received between the shell and the cover and for disposing in the driving shaft.

2. A quick switch hand tool as claimed in claim 1, wherein the base board defines a space, with each of two side walls of the space including a slot, with the quick switch hand tool further comprising a plate installed on another side of the base board and against the shell.

3. (canceled)

4. (canceled)

5. A quick switch hand tool as claimed in claim 1, wherein the retaining portion has three concavities.

6. A quick switch hand tool as claimed in claim 1, wherein a wall of the actuating member includes a protruding portion, with a coupling hole formed on the shell and the protruding portion mounted in the coupling hole.

7. A quick switch hand tool as claimed in claim 1, wherein an end of the two actuating blocks forms an engaged portion engaging with the ratchet and another end of the two poke blocks defines an extending portion, with two coupling holes formed on the shell, and with the extending portion mounted in the coupling holes.

8. (canceled)

9. (canceled)

10. A quick switch hand tool as claimed in claim 1, wherein an end of the cover forms a concave portion receiving the quick actuating member.

11. A quick switch hand tool as claimed in claim 1, wherein the shell is U-shaped and covers the cover.

12. A quick switch hand tool as claimed in claim 1, wherein an interior of a compartment of the cover defines a plurality of holes.

13. A quick switch hand tool as claimed in claim 12, wherein the plurality of holes receives the plurality of tool bits.

14. A quick switch hand tool as claimed in claim 1, wherein an actuating portion is formed on an end of the cover opposite to the driving portion.

15. A quick switch hand tool as claimed in claim 1, wherein the cover covers the shell, and the cover is pivotally disposed relative to the shell on the driving shaft.

16. A quick switch hand tool as claimed in claim 2, wherein the base board includes a protrusion near the slot, with an elastic element mounted on the protrusion.

17. A quick switch hand tool as claimed in claim 2, wherein the base board includes a connecting portion near the space.

18. A quick switch hand tool as claimed in claim 17, wherein a recess extends from a side of the space to the connecting portion and receives an elastic portion and a ball.

19. A quick switch hand tool comprising:
a base board including a space, and two side walls of the space respectively defining a slot;
a plate including a through hole, with the plate installed on a side of the base board and the through hole corresponding to the space;
a driving shaft disposed in the space of the base board and including a driving hole on an end thereof and a driving head on another end thereof, wherein the driving hole and the driving head respectively protrude from the base board and the plate;
a ratchet mounted on the driving shaft;
switch means received in the space of the base board, wherein the switch means comprises an actuating member, two actuating blocks, and two elastic elements, with two ends of the actuating member respectively including a pawl protruding from the slot of the base board, with two recesses formed on the actuating member receiving the actuating blocks engaging with the ratchet, and with the elastic elements pressing the poke blocks; and
a quick actuating member mounted on the driving shaft, protruding from the plate and for turning the driving shaft.

20. (canceled)

21. A quick switch hand tool as claimed in claim 19, wherein the base board includes a protrusion near the slot, with an elastic element mounted on the protrusion.

22. A quick switch hand tool as claimed in claim 19, wherein the base board includes a connecting portion near the space.

23. A quick switch hand tool as claimed in claim 22, wherein a recess extends from a side of the space to the connecting portion and receives an elastic portion and a ball, and a retaining portion formed on the poke member corresponding to the ball.

24. A quick switch hand tool as claimed in claim 23, wherein the retaining portion has three concavities.

25. A quick switch hand tool as claimed in claim 19, wherein a wall of the actuating member includes a protruding portion, wherein a coupling hole is formed on the shell, with the protruding portion mounted in the coupling hole.

26. A quick switch hand tool as claimed in claim 19, wherein an end of the two actuating blocks forms an engaged portion engaging with the ratchet and another end of the two actuating blocks defines an extending portion, with two coupling holes formed on the shell, and with the extending portion mounted in the coupling holes.

27. (canceled)

28. (canceled)
